(19) United States
(12) Patent Application Publication
(10) Pub. No.: US 2014/0007440 A1
(43) Pub. Date: Jan. 9, 2014

(54) STRING LINE POSITIONING AND SECURING DEVICE

(71) Applicant: Jason Cain, Como (AU)

(72) Inventor: Jason Cain, Como (AU)

(21) Appl. No.: 13/935,199

(22) Filed: Jul. 3, 2013

(30) Foreign Application Priority Data
Jul. 3, 2012 (AU) 2012902845

(51) Int. Cl. G01B 3/00

(52) U.S. Cl. CPC G01B 3/00
USPC 33/413

(57) ABSTRACT

A string line positioning and securing device that includes a body portion having a connection at one end for securement to a structure or substrate; and a frictional string retaining formation disposed on the body at a predetermined offset remote from the connection. In the preferred form the string retaining formation includes a string locking v-groove formed on the periphery of a head portion of the device, and an aligning slot that aligns the string and feeds it into the centre of the locking groove. Ideally the device includes a nail like penetration formation for securing to a substrate and an offset bearing surface to enable removal with a claw hammer.

### CROSS-REFERENCE TO RELATED APPLICATIONS

This application claims priority to Australian Provisional Patent 2012902845 Application No. filed Jul. 3, 2012, and Australian Patent Application No. 2013203350 filed Apr. 10, 2013 the disclosures of which are incorporated in their entirety by reference herein.

### FIELD OF THE INVENTION

The present invention relates to a positioning and securing device for string lines of the kind commonly used in construction to provide a straight line datum or guide.

### BACKGROUND

Any discussion of the prior art throughout the specification should in no way be considered as an admission that such prior art is widely known or forms part of common general knowledge in the field.

String lines, which in their most basic form are simply tensioned lengths of string, are commonly used by builders and landscapers and the like, for establishing a straight line guide to which a frame, wall or other edge formation can be aligned during the construction process.

Typically, the string line is supported between two spaced protruding fasteners, such as partially embedded screws or nails, which are first secured into selected positions of an adjacent structure or substrate. Usually, the string line is provided on a reel and will have a loop tied in at one end which is slid over the first fastener. The string is then extended to, and wrapped around, the second fastener and then tensioned to form a taut straight line, after which it has to be tied off in some manner to retain the tensioned string in position.

This process of “tying off” can be difficult for several reasons. Firstly, it is usually a two handed job, which when up a ladder or in limited spaces, can be very awkward, as well as being potentially dangerous. Further, the process is exacerbated by the need not only to retain tension during the securing process, but having in most cases to deal with the added inconvenience of the reel of remaining string being present at that end of the line. In this regard, the aim is ideally never to cut a string line, so that it can then be used repeatedly over a wide variety of distances or lengths.

While wrapping the string around two horizontally oriented fasteners accurately locates the string along a line within a plane through which the string and fasteners extend, it may also be important to accurately locate the string within another plane. For example, when setting a string line off a wall frame to then align some form of vertically disposed cladding, the fasteners will likely be driven into a vertical face of the frame, but horizontal alignment with respect to the distance from the wall will be very important. In these instances it is necessary to provide an accurate offset from the vertically extending structure to which the fasteners have been secured, and the height positioning of the fasteners is only relevant if seeking to align a horizontally extending edge at a predetermined height.

When using fasteners such as regular nails or screws secured to a vertical surface, the required offset from that surface is sometimes achieved by sliding the string at its points of contacts with the fasteners into the correct position and/or attempting to control the offset from the structure to the fastener head when the fastener is inserted. Not only can these steps be time consuming, the string line may later be caused to move out of alignment if bumped adjacent the fastener. While this can be alleviated by using some form of separate spacer element against which the string can rest, this still represents yet another time consuming and complex step in the process.

It is an object of the present invention to provide a string line positioning and securing device that overcomes or ameliorates one or more of the disadvantages of the prior art, or which at least offers a useful alternative.

### SUMMARY

According to the invention there is provided a string line positioning and securing device comprising:
a body portion having connection means at one end for securement to a structure or substrate; and
a frictional string retaining formation disposed on the body at a predetermined offset remote from the connection means.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The term “frictional” is used herein to include various friction assisted clamping arrangements of the kind described here after in more detail.

In a preferred form, the connection means comprises a longitudinally extending penetration formation for penetrating a structure or substrate for securement thereto. Preferably the penetration formation is in the form of a nail type extension that is ideally integrally formed with the device. However, screw formations, preferably self drilling/tapping, may also be used and/or the device could include a connection means in the form of a mounting flange configured for use with independent securing means.

Preferably the device includes a stop formation adjacent the connection means which in use will abut a surface of the substructure or substrate. In the preferred form that incorporates a nail type penetration formation, the stop is in the form of a shoulder formation located at the distal end of the penetration formation that limits the depth to which the penetration formation can be driven into the substructure or substrate.

Desirably, the body portion includes a spacer region of predetermined length that extends from the stop formation which, in use, will sit against the substructure or substrate, to the frictional string retaining formation so as to achieve the required offset.

In embodiments that include a nail type penetration formation, the device further includes an undercut region, ideally intermediate the stop formation and the frictional string retaining formation, that provides a bearing surface that faces toward the penetration formation that is configured to enable a claw hammer to be readily used to remove the device from a structure after use.

The frictional string retaining formation is ideally located adjacent the end of the body remote from the connection formation.

In a first preferred form, the frictional string retaining formation includes a peripherally extending v groove sized such that when the tensioned string is wound into the groove it is frictionally retained by, and locks into, the groove. Preferably the device has a generally circular cross section along its length and the v groove extends circumferentially around a head portion of the body remote from the penetration formation.

Ideally, an aligning slot is also provided on the head portion of the body which extends in a plane parallel to, and across, the plane of the circumferential groove, which extends into the body to intersect with the locking groove. Ideally the base of the slot is at a location of around 0.5 to 1.0 mm below the centre line of the groove. In this manner, the tensioned string can be first drawn through the aligning slot, and then wound around the intersecting locking v groove. The offset is set by the distance between the shoulder or stop formation and the centre of the locking groove or the lowest point of the aligning slot if this is above the centre of the locking groove.

The groove dimensions are selected to functionally achieve a friction locking effect when the string line is wound under tension into the groove. The exact dimensions required to make this work may depend to some degree on the string material properties, the overall size of the head of the device and the diameter of the string.

For a commonly available standard string line having a typical string diameter of about 1.5 mm, the groove has taper angle of approximately 24 to 30 degrees, or more preferably around 26 degrees, with a depth of around 3 mm. Preferably the width of the aligning slot is approximately 2-2.2 mm, ideally with a 0.3 mm chamfer or similar to help lead the string into the slot.

In one particularly preferred form the overall length of the device is approximately 28-36 mm, ideally around 29 mm, the penetration formation having a shaft diameter of around 4 mm and a shaft length to the point of approximately 8-18 mm, preferably 10 mm. The head width is around 12 mm with a slot having a depth of 3 to 4.5 mm, ideally 3 mm. The centre of the circumferential groove is around 3.0 mm from the top of the head portion. Ideally the undercut region narrows down to around 4 mm diameter, extends for at least 3 mm to 5 mm and terminates at a planar bearing surface transverse to the axis of the device at a distance of around 11 mm from the end of the penetration formation stop formation.

In a second embodiment, the frictional string retaining formation comprises a pair of domed spring washers retained on the body of the device to define a tapered locking groove there between that extends circumferentially in a similar location to that in the first embodiment. In this embodiment, the string is forced under tension between the two domed washers, which by virtue of the spring loading created by the string being driven into the tapered groove, deforms the washers which, in then trying to return to their original shape, act to clamp the string in position.

In a third embodiment, the frictional string retaining formation comprises a cross groove formed in a head portion of the device that includes a series of unidirectional saw tooth formations or similar that extend transverse to the groove. Ideally the groove is also tapered towards the penetration formation in a similar manner to an open v-cleat or jammer of the kind commonly used in sailing. In this manner a string can be pulled into the serrated edge cross groove in a direction aligned with the serrations and tensioned longitudinally, while at the same time being forced downward into the tapered groove, such that on release the string tries to retract within the groove and is retained by the reverse edges of the serrations.

In a fourth embodiment, which is a variation to the third embodiment that works on a similar principle, the frictional string retaining formation may comprise two pivoting cam elements with opposing serrated edges which are biased towards engagement in a similar manner to a cam cleat arrangement commonly used on yachts and the like. Once again the string can be passed through and tensioned in one direction, but is easily removed by simply moving in a direction transverse to, or generally out of, the plane in which the cam cleats are pivoting.

In the second and third embodiments the frictional string retaining formation may additionally include a locking groove into which a portion of the excess string can be wound after passing through either the serrated cross groove or between the serrated clamping elements, to further contribute to the act of locking off the string.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

### BRIEF DESCRIPTION OF THE DRAWINGS

Preferred forms of the invention will now be described, by way of example only, with reference to the accompanying drawings in which:

FIG. 1 is a perspective view of a string line positioning and securing device according to a first aspect of the invention;

FIG. 2 is a sectional side view of the string line positioning and securing device shown in FIG. 1;

FIG. 3 is a sectional side view of a second embodiment string line positioning and securing device according to the invention;

FIG. 4 is a sectional side view of a third embodiment string line positioning and securing device according to the invention;

FIG. 5a is a schematic plan view of two first embodiment string line positioning and securing devices in use illustrating the steps involved in securing the string line between the two devices; and

FIG. 5b is a schematic side view of arrangement shown in FIG. 5b.

### DETAILED DESCRIPTION

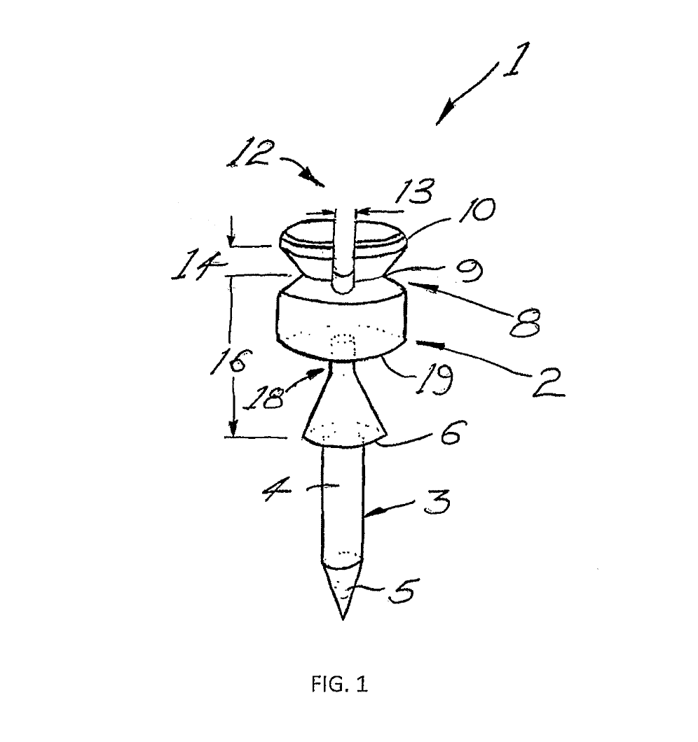

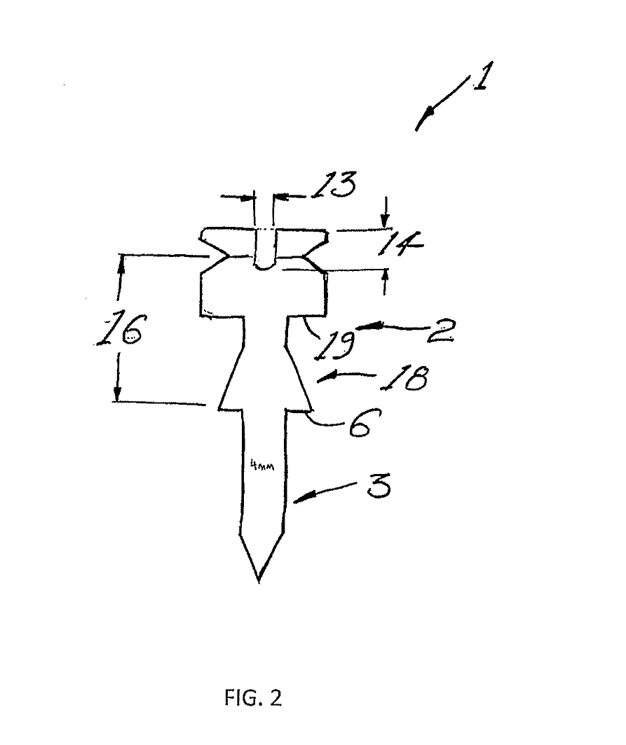

Referring to the accompanying drawings and initially to FIGS. 1 and 2, there is shown a first embodiment string line positioning and securing device 1 according to the invention. The device 1 includes a body portion shown generally at 2 which at one end includes connection means in the form of a ‘nail’ like longitudinally extending penetration formation 3 for securing the device to a structure or substrate. The penetration formation 3 includes a shaft section 4 terminating in a penetrating driving point 5. The shaft 4 of the penetration formation 3 terminates at its other end remote from the penetrating point 5, at a stop formation in the form of a shoulder 6 which extends radially outwardly beyond the diameter of the shaft 4 so as to limit the depth to which the device 1 can be driven into a substrate.

The device 1 also includes a frictional string retaining formation shown generally at 8 which in the illustrated embodiment is located at the end of the body to remote from the penetration formation 3. In this first preferred form, the frictional string retaining formation 8 includes a peripherally extending v groove 9 which is sized such that when the tensioned string is wound into the groove it is frictionally retained by, and locks into, the groove.

In this embodiment, the device has a generally circular cross-section along its length, and the v groove 9 extends circumferentially around an end of the body remote from the penetration formation 3 and terminates in a circular head portion 10. Extending across the end face 11 of the head portion 10, is a string aligning slot 12 which extends in a plane parallel to, and across, the plane of the circumferential v groove 9. The string aligning slot 12 has a width 13 selected to readily receive the string and extends axially toward a central plane of the circumferential v groove 9 to a depth 14 so as to intersect and penetrate adjacent or ideally below that plane.

Disposed between the shoulder 6 at the proximal end of the penetration formation 3, and the head portion 10, is a spacer region 16 sized to provide a predetermined offset distance between the face of the shoulder 6 and the plane of the string retaining v groove 9.

Disposed within the spacer region 16, is an undercut region 18 that is shaped to define a bearing surface 19 which faces away from the head portion 10, the bearing surface and undercut region being sized and configured to enable the claws of a claw hammer to be used to readily remove the device from a substructure or substrate after it has been used.

The groove dimensions are selected to functionally achieve a friction locking effect when the string line is wound under tension into the groove. The exact dimensions required to make this work may depend to some degree on some or all of the following: the string material properties, the overall size of the head of the device, the diameter of the string and the tightness of the string in the aligning slot, where one is provided.

For a commonly available standard string line having a typical string diameter of about 1.5 mm, the groove has taper angle relative to the centre line of the groove of approximately 24 to 30 degrees, or more preferably around 26 degrees, with a depth of around 3 mm. Preferably the width of the aligning slot is approximately 2-2.2 mm, ideally with a 0.3 mm chamfer or similar to help lead the string into the slot.

In one particularly preferred form the overall length of the device is approximately 28-36 mm, ideally around 29 mm, the penetration formation having a shaft diameter of around 4 mm and a shaft length to the point of approximately 8-18 mm, preferably 10 mm. The head width is around 12 mm with a slot having a depth of 3 to 4.5 mm, ideally 3 mm. The centre of the circumferential groove is around 3.0 mm from the top of the head portion. Ideally the undercut region narrows down to around 4 mm diameter, extends for at least 3 mm to 5 mm and terminates at a planar bearing surface transverse to the axis of the device at a distance of around 11 mm from the end of the penetration formation stop formation.

In other embodiments, the aligning slot may also be tapered to provide a first frictional locking effect prior to the string being wound into the peripherally extending v-groove.

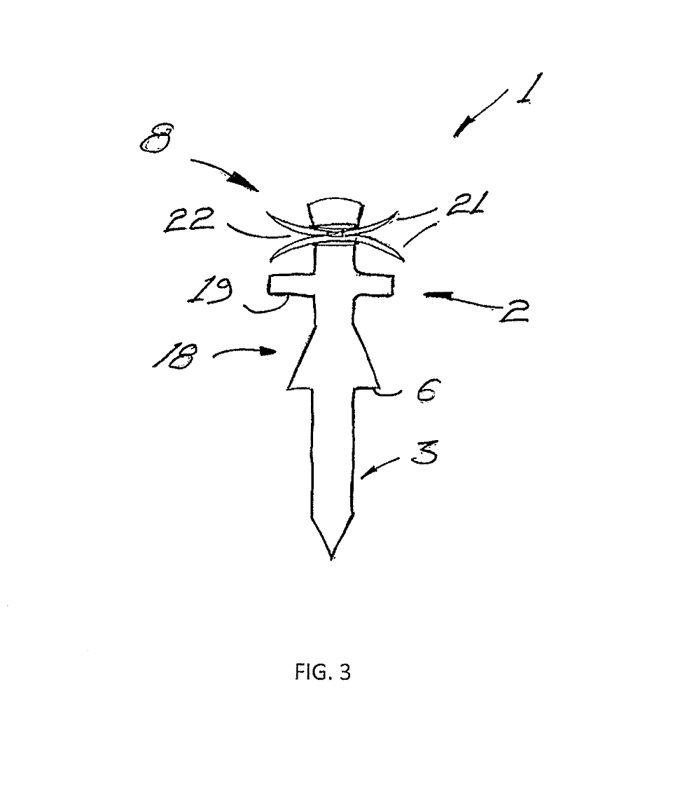

Referring next to FIG. 3, there is shown a cross sectional view of a second embodiment string positioning and securing device according to the invention. Like references numerals have been used to denote corresponding features.

As can been seen, the device once again incorporates connection means in the form of a nail type penetration formation 3, a depth limiting stop in the form of a shoulder formation 6, and means to facilitate removable of the device after use that includes an undercut region 18 that defines a bearing surface 19 against which the prongs of a claw hammer can be applied.

The primary difference between this and the first embodiment relates to the form and structure of the frictional string retaining formation. In this particular embodiment, the frictional string retaining formation 8 comprises a pair of domed spring washers 21. These are retained on the body 2 to define a tapered locking groove 22 there between, that extends circumferentially in a similar location to that of the first embodiment. In use, the string is forced under tension between the two domed washers 21, which by virtue of the spring loading created by the string being driven into the tapered groove, deforms the washers which, in then trying to return to their original shape, act to clamp the string in position. When the string is pulled axially outwardly from the groove, the tension in the washers is released and the clamping action on the string is similarly reduced so the string can be released.

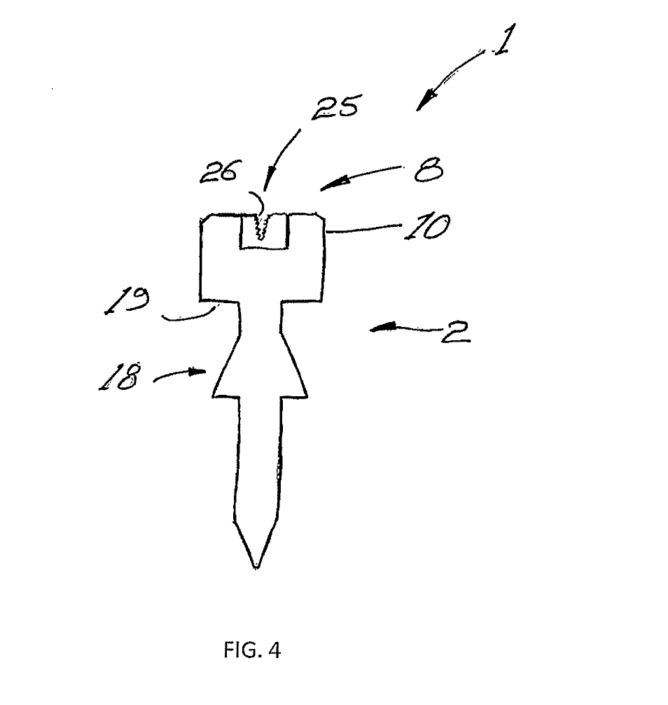

FIG. 4 is a sectional view of a third embodiment of a string line positioning and securing device 1. Once again, those features relating to the means by which the device is attached and removed have remained the same, and once again it is the frictional string retaining formation that has been varied. In this embodiment, the frictional string retaining formation 8 comprises a cross-groove 25 formed in the head portion 10 that is preferably tapered inwardly and which includes a series of unidirectional saw tooth formations 26 or similar that extend transverse to the longitudinal axis of the groove 25. In this manner, a string can be pulled into the serrated edge cross-groove in a direction aligned with the serrations and tensioned longitudinally, while at the same time being forced downward into the tapered groove, such that when the tension is released, the string tries to retract within the groove and is retained by the reverse edges of the serrations. It is envisaged that the device would operate in a similar manner to an open v-cleats or jammers of the kind, commonly used to retain ropes on sailing boats and the like. This embodiment could also include a clip or lever element to hold the string in the serrated groove.

In a fourth embodiment (not illustrated), which is a variation to the third embodiment, the frictional string retaining formation may comprise two pivoting cam elements with opposing serrated edges, which are elements are biased towards engagement in a similar manner to a cam cleat device of the kind used on yachts. Once again, the string can be passed through and tensioned in one direction while being locked in the reverse direction, but is easily removed by simply moving in a direction transverse to, or generally out of, the plane in which the cam cleats are pivoting.

In each of these alternative embodiments, the frictional string retaining formation may additionally include a locking groove similar to that of either the first or second embodiment into which a portion of the excess string can be wound after passing through either the serrated cross-groove or between the serrated clamping elements to further contribute to the act of locking off the string. Similarly, additional string retaining elements could be provided that help retain the string in locking engagement with the device. Such elements could include pivoting arm elements or over centre toggle devices or any other suitable means.

Additionally, the device of the first embodiment may be configured to work without the string aligning slot so as to rely solely on the circumferential locking groove as per the second embodiment shown in FIG. 3.

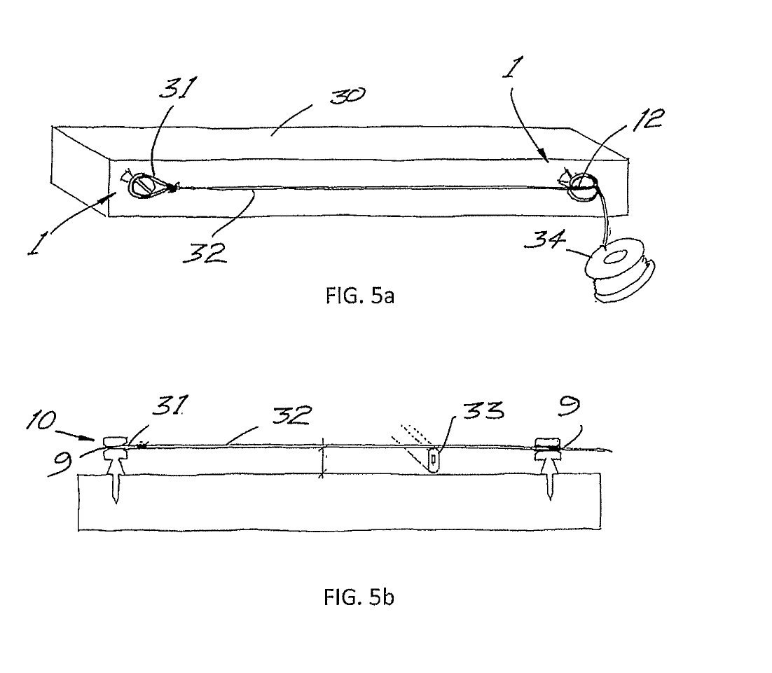

Turning next to FIGS. 5a and 5b, typical use of the first embodiment string line positioning and securing device according to the invention will now be described.

Referring first to FIG. 5a, two of the positioning and securing devices 1 are secured into the substrate shown generally at 30. A loop 31 is formed in the free end of the string 32 and secured by passing over the head portion 10 of the first device such that the loop 31 seats within the v-groove 9. In the preferred embodiment the offset from the seat of the v-groove 9 to the shoulder 6 is around 14 mm which is the width of a typical builders pencil 33 as shown in part in the drawing.

The string is then extended and unwound from a reel 34 until it reaches the second string positioning and securing device 1 located at the other end of where the string line is to be set. The line is passed through the slot 12, which ideally has been oriented to align with the general direction in which the string extends, and tensioned. The string is then wound tightly into and around the circumferential groove 8. It has been found that with the correct geometry, in most instances, simply winding the string a couple of times around the groove, is sufficient to fasten off the tensioned string. However, additional securing can be achieved by, for example, winding the string in a figure of eight configuration through the slot, around one half of the groove, back through the slot and again around the other half of the groove etc.

As will be clear, the string securing and tensioning device of the invention offers numerous advantages over the prior art. In this regard the offset is accurately set by the structure of the device and there is no risk of the string slipping along the axis of the device once it has been secured within the groove. It can also enable the line to be readily fastened using only one hand, as there is no need to hold another portion of the string in the other hand, as is the case with most existing tying off techniques. Similarly, the string is easily released and removed when the line is no longer required without the need to undo large numbers of twists or difficult knots. The device thereby enables huge time savings and also contributes to safer on site practices.

While the invention has been described with reference to various specific examples, it will be appreciated that the invention is not limited to variants described herein, and could readily be embodied in many other forms.

What is claimed is:

1. A string line positioning and securing device comprising:
a body portion having connection means at one end for securement to a structure or substrate; and
a frictional string retaining formation disposed on the body at a predetermined offset remote from the connection means.

2. The string line positioning and securing device according to claim 1 wherein the connection means comprises a longitudinally extending penetration formation for penetrating a structure or substrate for securement thereto.

3. The string line positioning and securing device according to claim 2 wherein the penetration formation is a nail like spike formation.

4. The string line positioning and securing device according to claim 1 wherein the device includes a stop formation adjacent the connection means which in use will abut a surface of the substructure or substrate to which the device is attached.

5. The string line positioning and securing device according to claim 4 wherein the connection means comprises a longitudinally extending nail like spike penetration formation for penetrating a structure or substrate for securement thereto and the device further includes an undercut region, intermediate the stop formation and the frictional string retaining formation, that provides a bearing surface offset from the stop formation that faces toward the penetration formation that is configured to enable a claw hammer to be readily used to remove the device from a structure after use.

6. The string line positioning and securing device according to claim 1 wherein the frictional string retaining formation includes a peripherally extending v groove sized and configured such that when a tensioned string is wound into the groove, it is frictionally retained by, and locks into, the groove.

7. The string line positioning and securing device according to claim 6 wherein the device has a generally circular cross section along its length and the v groove extends circumferentially around a head portion of the body remote from the penetration formation.

8. The string line positioning and securing device according to claim 7 wherein an aligning slot is also provided on the head portion of the body which has an opening in a plane parallel to the plane of the circumferential groove, which also extends into the body to intersect with the locking groove at a location below a centre line of the groove.

9. The string line positioning and securing device according to claim 8 wherein the aligning slot includes a flared opening to assist guidance of the string into the slot.

10. The string line positioning and securing device according to claim 6 wherein the groove has taper angle relative to the centre line of the groove of approximately 26 degrees.

11. The string line positioning and securing device according to claim 1 wherein the frictional string retaining formation comprises a pair of domed spring washers retained on the body of the device to define a tapered locking groove there between that extends circumferentially into which the tensioned string can be wound and clamped

12. The string line positioning and securing device according to claim 1 wherein the frictional string retaining formation comprises a cross groove formed in a head portion of the device that includes a series of unidirectional saw tooth formations or similar that extend transverse to the groove which, groove is also tapered towards the penetration formation in a similar manner to an open v-cleat or jammer.

13. The string line positioning and securing device according to claim 1 wherein the frictional string retaining formation comprises two pivoting cam elements with opposing serrated edges which are biased towards engagement in a similar manner to a cam cleat arrangement.

14. The string line positioning and securing device according to claim 11 further including a peripherally extending v groove sized and configured such that when a tensioned string is wound into the groove, it is frictionally retained by, and locks into, the groove.
